(19) United States
(12) Patent Application Publication
(10) Pub. No.: US 2004/0169312 A1
(43) Pub. Date: Sep. 2, 2004

(54) Sculpture method utilizing new means of simulating, viewing, and displaying sporting, undersea and other environments

(76) Inventors: Phil Dean Roberts, Corona Del Mar, CA (US); Robert Nealy, San Clemente, CA (US); Robert Eubank, Vista, CA (US)

Correspondence Address: Eric Hanscom, Suite 204, 6994 El Camino Real, Carlsbad, CA, 92009, US

(21) Appl. No.: 10/781,587

(22) Filed: Feb. 17, 2004

Related U.S. Application Data
(60) Provisional application No. 60/450,342, filed on Feb. 28, 2003.

(51) Int. Cl. B29C 33/40

(52) U.S. Cl. 264/222

(57) ABSTRACT

This invention is directed toward a sculpture, and the method of making the sculpture, utilizing a mold and manufacturing method in which the underside of the mold mimics the top of an ocean bottom, or other underwater environment, which can be painted to realistically depict different types of corals and fishes. This ocean bottom can be seen through clear, smooth-surfaced sections of the front, sides, and back of the sculpture, thereby creating an “aquarium view” of the ocean bottom. The invention also contains a fish-eye lens, which can be moved in several directions, thereby affording a user numerous views of the surfer, wave, and ocean bottom from different perspectives, or of other aquatic sportspeople engaging in various aquatic sports. The fish-eye lens can be mounted above the water, or at the waterline, thereby affording a view of the environment and actions both above and below the waterline.

### CROSS REFERENCE TO RELATED APPLICATIONS

This is meant as a continuation application based on a Provision Application entitled SCULPTURE METHOD UTILIZING NEW MEANS OF SIMULATING, VIEWING, AND DISPLAYING SPORTING, UNDERSEA AND OTHER ENVIRONMENTS, filed Feb. 28, 2003 and given U.S.PTO No. 60/450,342 (copy attached).

### STATEMENT REGARDING FEDERAL SPONSORSHIP OF RESEARCH

This invention was not federally sponsored.

### BACKGROUND OF THE INVENTION

This invention is directed toward a sculpture, and the method of making the sculpture, utilizing a mold and manufacturing method in which the underside of the mold mimics the top of an ocean bottom, or other underwater environment, which can be painted to realistically depict different types of corals and fishes.

This ocean bottom can be seen through clear, smooth-surfaced sections of the front, sides, and back of the sculpture, thereby creating an “aquarium view” of the ocean bottom. The invention also contains a fish-eye lens, which can be moved in several directions, thereby affording a user numerous views of the surfer, wave, and ocean bottom from different perspectives, or of other aquatic sportspeople engaging in various aquatic sports. The fish-eye lens can be mounted above the water, or at the waterline, thereby affording a view of environments and actions both above and below the waterline.

Sculpture has been a popular art form since around 30,000 B. C., which is the approximate date that the earliest sculptures found were created. While the early Germanic peoples who created these sculptures have been credited as the earliest “sculptors”, there is another line of reasoning which holds that sculpture is an art form that should really go back to the earliest wooden clubs. In any case, sculpture has been an accepted form of re-creating objects and making artistic statements for much of human history.

Over the years, sculpture has evolved from basic wooden carvings and clay molding to active manipulation of a variety of media. Three dimensional sculpture aimed toward faithfully re-creating a scene has become one of the more popular forms of sculpture, with a number of recreations, whether miniature or full size, of famous landmarks and scenes from human experience providing entertainment and profit to locations ranging from prestigious art galleries and museums to tacky gift shops and souvenir stands.

Re-creating ocean and other water environments has been a goal of many artists who enjoy aquatic sports and the unique environment of the locales in which aquatic sports take place. There have been numerous attempts to portray three-dimensional aquatic environments as a way to allow people to “experience” what is otherwise a fairly hostile environment. Many of these attempts have aimed toward allowing a land-based human to see what an aquatic environment really looks like—the most common example of this is the common aquarium, which allows a viewer to see how fish and other aquatic animals swim, eat, and reproduce. To date, however, there has not been invented a device which accurately depicts the sport of surfing, and other aquatic sports, so that a non-surfer can visualize how the various components of surfing—the surfer, the surfboard, the wave, and the ocean bottom—all interrelate to result in the exhilaration of a surfing ride. The present invention addresses this need.

The invention has a number of possible iterations, but we shall use the sport of surfing as an example to illustrate the various aspects of the invention, as it is the best mode of this invention.

It would be useful to describe some basic terminology relating to ocean waves and surfing in general so that a reader has adequate knowledge to appreciate and practice the invention. The vast majority of the waves used by surfers for surfing are created by wind blowing over the ocean's surface. The size of the wave depends upon the velocity of the wind, the amount of time the wind blows, and the fetch, or the size of the area over which the wind blows. As the waves move toward a shallow ocean bottom (usually found near the coastline, with some notable exceptions such as the Cortes Bank, which is a submerged reef over a hundred miles off the California coast), the waves become more steep. When the water is approximately one and one half times deeper than the wave is tall, the wave begins to break. If the ocean bottom gradually becomes shallower —such as occurs with some of the gently sloping sandbars off the California coastline—the wave will gently spill over, creating a weakly breaking wave which is ideal for beginners. In areas where the ocean bottom rises more abruptly —such as the coral reefs of Hawaii and other tropical locations—the waves break with much more force, and the top of the wave races over the bottom of the wave, resulting in a “top to bottom” break which frequently pitches out so far and so quickly that it creates a hollow cylinder of air inside the wave, which is called the tube.

No matter how the wave breaks, all waves have a front face, which is the part of the wave which faces the beach, and a back face, which faces out to sea. A person standing on the beach will always see the front face; a boat out beyond the breakers will always see the back face. A surfer (or surf photographer) to the side of a breaking wave can get a view sideways down the wave “down the line”, such that he/she can see a surfer inside of the tube. This is considered one of the optimum views of a surfer in action. Another very popular view of the surfer is an underwater view, taken usually by a surf photographer who has positioned himself/herself such that the wave rolls over his/her head with a surfer only a few feet away, allowing a shot from underwater which shows the silhouette or shadow of the surfer against the texture of the front face of the wave.

The object of surfing is to position the surfboard either in the tube or directly in front of the breaking portion of the wave, an area known as the “pocket” of the wave, which contains the most energy and allows for the most explosive and radical maneuvers. A skilled surfer performs a variety of maneuvers designed to keep the surfboard around the pocket, including stalls, cutbacks, 360's, rollercoasters, and bottom turns. It is the profession of the surf photographer to capture these maneuvers and record them for the enjoyment of the general public in the form of magazine pictures and surf movies. While there have been attempts to capture the beauty, thrills, and inherent danger in the sport of surfing in three-dimensional form, prior to this invention such attempts have failed to adequately portray the surfing environment as a whole. The present invention meets this long-felt need by faithfully replicating the surfing environment —including the wave form, the act of surfing the wave, and the underwater environment beneath the wave—in a means which is both eye-pleasing and readily lends itself to mass production via molds. The invention has a number of components which will be discussed below.

A major part of the invention is the use of a clear, transparent backsides and sides to the wave, and a clear front portion of the wave, such that a person can view the back, sides, and front of the sculpture and see through the wave. This provides two unique and attractive views which prior to this invention were not utilized. First, a viewer can see the texture of the wave face on the front of the wave. As illustrated by the figure, the wave face of these sculptures is textured in a manner such that it appears similar to the wind-whipped face of an actual ocean wave. The transparent resin or plastic from which the sculpture is created allows a viewer to see a vague silhouette or shadow of the surfer through the textured face of the wave. This type of view was popularized in the surf movie Free Ride, which was one of the pivotal surf films of the late 1970's. Free Ride was the first surf movie to make extensive use of the underwater perspective in shooting surfers as then traversed the wave faces. The present invention represents the first attempt to capture this perspective in a sculpture of the sport of surfing.

The second unique view the clear wave back provides is in allowing a viewer to see an artist's rendition of the ocean bottom and its flora and fauna at a particular geographic location. Due to the differences in water temperature at different latitudes, ocean currents, sedimentary deposition sources such as rivers, and other variables, the ocean bottom upon which waves break, along with the associated fish, invertebrates, and marine algae and plants varies dramatically throughout the world. The present invention captures these different ocean bottoms, ranging from the jagged coral reefs and colorful fishes of Hawaii to the sand bottoms, eelgrass, bat rays and sharks found in many California surf spots. The equipment used by the surfer will also vary with the wave conditions. For example, the surfer on the small wave in Southern California surfs a “cruiser” longboard and wears surf trunks, the Hawaiian surfer needs a tri-fin thruster and strong surf leash to handle the powerful reef surf found in the Islands, while the Northern California surfer wears a wetsuit, booties, and a hood for protection against the cold waters.

Another major part of this invention is the method by which the ocean bottoms are created. Artists such a Wyland and Lassen have captured the beauty of the different underwater scenes in their two-dimensional paintings and murals, but prior to this invention there has not been a sculpture which recreates a three-dimensional view of the underwater environment. The method of recreating the underwater scene is an essential part of this invention as it utilizes a potentially far-ranging process which lends itself readily to mass production, and is not limited to merely faithfully re-creating ocean bottoms. Rather, this method has clear applicability to rivers, swimming pools, diving pools, undersea SCUBA diving environments, and even miniatures of famous waterfronts throughout the world.

To recreate an ocean bottom, the invention relies upon an artist to make a clay mold of an ocean bottom environment using traditional potter's tools along with Dremels and other motorized devices. Each item in the ocean bottom, including the substrate, corals, fish, algas, plants, and other unique characteristics of each sculpture's environment are individually handcrafted into the clay mold, along with the shapes of the wave and surfer. The clay mold, when finished, is then used as the sample from which a metal mold is created.

After the metal mold is formed, mass production of the sculpture is commenced. After each sculpture is finished, a painter applies a variety of paints to the underside of the sculpture so that each indentation is painted in realistic colors and tones to mimic its real life counterpart. The finished result is such that a viewer sees the ocean bottom and its associated flora and fauna from an “aquarium view”, which realistically depicts a number of different ocean/surf environments in a manner which allows a viewer to feel that he/she is a part of the environment.

The invention as it relates to the sport of surfing has two basic iterations, both of which are readily adaptable to the further sports, hobbies, and landmarks discussed later in this patent. First, the sculpture can be designed for viewing solely as a three-dimensional sculpture, with attractive views offered on all four sides. From the direct front of the sculpture, the viewer will see a normal view that a beachgoer would see as he/she looked out into the waves. The two end views would simulate a “surfer's view” which would be seen by another surfer paddling out through the waves looking “down the line” into a wave being surfed by another surfer. The back view would be the aforementioned “aquarium view” through the back of the wave which encompasses both the textured face of the wave and the surfer silhouette on the other side of the textured face, and the locale-specific ocean bottom.

A second iteration of the surfing sculpture involves the use of a “fish-eye” viewer which is enclosed in a circular cavity molded into the sculpture. The viewer allows a user of the invention to view the surfer from inside the “tube”, which is a cylindrically hollow wave caused by the wave breaking over a rapidly rising ocean bottom, whereupon the top portion of the wave “pitches out” and creates a hollow cylinder through which a skilled surfer can ride his/her surfboard. The eyepiece can be either fixed or moveable. With the fixed eyepiece, the only view a user has is of the wave tubing over the head of the surfer. With the moveable eyepiece, a user can view the surfer from different angles, as well as directing the eyepiece down toward the ocean bottom, allowing for an attractive view of the sand, coral, sponges, algas, seaweeds and fishes found on ocean bottom (“algas” are aquatic plants such as kelp which reproduce without the seeds found in real plants, sexually reproducing marine plants are generally called “seaweeds”).

The “fish-eye” viewer has further applications to “split-level” views of the air/water interface. Since many water sports take place at least partially on the surface of the water, the invention can be used to simulate the view an ocean sport enthusiast will get when he/she is looking above and below the waterline. For sports such as surfing, snorkeling, fishing, and kayaking, the surface of the ocean or river bottom over which the sport or hobby takes place is as important as what is happening on the surface of the water, both in terms of the beauty of the underwater environment and because the wave action is directly tied to the bottom configuration of the ocean or river bottom over which the action is taking place.

The invention also lends itself to a number of additional sports and hobbies—the sport of surfing was used here merely as an example. Among the other water sports which are captured in three-dimensional form by this invention are SCUBA diving, kayaking (river kayaking, sea kayaking, and surf kayaking), river rafting, boogie boarding, fishing (lake, stream, and saltwater), body surfing, snorkeling, boating, and water skiing. In all these sports there is either a unique underwater view found in the sport which can be successfully recreated using the methods and techniques of this invention or/and there is some element of speed or other movement which lends itself to simulation through the use of an eyepiece viewer. Non-water sports related applications include car racing, track and field events, skydiving, team sports such as football, baseball, basketball and hockey, and outdoor sports such as skiing, snowboarding, rock/mountain climbing, and hiking.

The invention can also be used as a method of replicating means of transportation and famous landmarks, including those found in the water (such as oil derricks, submarines, deep sea submersibles), those found on the air/water interface (Golden Gate Bridge, famous ocean-, river-, or lakefront towns such as New York, Chicago, Los Angeles, Hong Kong and Honolulu, and waterfront landmarks such as the Hotel Del Coronado, and those found on land such as famous ski resorts like Vail and Aspen.

A further use of the invention is to recreate scenes involving animals and plants, particular those found in water and on the air/water interface. Scenes such as bears trying to catch salmon, whales coming up for air, a shark chasing a large tuna, and pelicans swooping down to catch fish all lend themselves readily to being illustrated in attractive three-dimensional representation by this invention.

There are numerous examples in the prior art of sculpture methods. For example, U.S. Pat. No. 6,383,429 by Noto teaches a method of making a sculpture which, like the present invention, suggests the use of resin to make the molded object, but Noto's method calls for embedding one such resin object within another. It does not discuss the idea of molding an undersea or other environment into the back of the resin object, nor allowing for the undersea environment to be painted to resemble coral or other underwater environments, nor does it allow for an eyeglass viewer to allow a user to “zoom in” and “zoom out” to take different views of the object.

Further objects and features of this invention will be apparent to one skilled in the art. It will be readily apparent to those skilled in the art that still further changes and modifications in the actual concepts described herein can readily be made without departing from the spirit and scope of the invention as defined by the description of this invention. It is particularly stressed that this invention is readily applicable to a number of different sports, as well as famous landmarks—both natural and human-made, and that the surf sculpture example illustrated here is not in any way meant to limit the scope of this patent.

### BRIEF SUMMARY OF INVENTION

This invention is directed toward a sculpture, and the method of making the sculpture, utilizing several unique methods of simulating, viewing, and displaying sporting, undersea and other environments. It is an object of this invention that a sculpture can be created by making a mold such that the underside of the mold mimics the top of an ocean bottom, or other aquatic bottom;

It is a further object of this invention that the “ocean bottom” can be painted in different colors which realistically depict different types of corals, fishes and other undersea plants, algas, and animals found in the particular environment the artist is trying to recreate.

If is a further object of this invention that the “ocean bottom” can be seen through clear, smooth-surfaced sections of the front, sides, and back of the sculpture, thereby creating an “aquarium view” of the ocean bottom.

It is a further object of this invention that a user can view the surfer or other aquatic sportsperson through the back of the wave and see a silhouette or shadow view of the surfer as he/she traverses the wave.

It is a further object of this invention that the user be able to get a view from inside the “tube” of the wave of a rider who is surfing out of the tube away from the viewer through the use of a “fish-eye” lens.

It is a further object of this invention that, through manipulating the “fish-eye” lens, the viewer can zoom in, zoom out, and maneuver the lens to change his/her perspective on the surfer, the wave, and the ocean bottom.

It is a final object of this invention that the “fish-eye” lens can be located at the water level, thereby affording a viewer views of both above and below the waterline.

### BRIEF DESCRIPTION OF THE DRAWINGS

FIG. 1 is front, partial elevational view of the invention showing the molded resin sculpture with the fish-eye lens in cross section. The lens in this figure is stationary.

FIG. 2 is a side view of the same molded resin sculpture as in FIG. 1, from the “tube” end of the sculpture, showing the view through the fish-eye lens of the surfer and the wave.

FIG. 3 is a front view of the sculpture showing the coral reef bottom aspect of one iteration of the sculpture.

FIG. 4 is a back view of the sculpture showing the coral reef bottom aspect and the shadow/silhouette view of the surfer and surfboard through the resin making up the wave itself.

FIG. 5 is a partial, front view of the fish-eye lens portion of the sculpture, showing the lens in its magnification mode, in which the lens can be screwed forward and backward along its screw threads to zoom in or zoom out on the surfer.

FIG. 6 is a partial, front view of the fish-eye lens portion of the sculpture, showing the lens in its pivot mode, in which the lens can be moved up and down or side to side, to afford a viewer a wide variety of different views of the surfer and the wave.

FIG. 7 is a rear view of the fish-eye lens portion of the sculpture, showing how the lens can be rotated 360 degrees around in its enclosure, at the same time being able to move up and down, thereby allowing a viewer to adjust his/her view.

FIG. 8 is a side view of the fish-eye lens located at the waterline, thereby affording the viewer views of both the above-waterline and below-waterline activities. In this figure, a kayak fisherman is used to illustrate the figure.

### DETAILED DESCRIPTION OF THE INVENTION

This invention is directed toward a sculpture, and the method of making the sculpture, utilizing a mold and manufacturing method in which the underside of the mold mimics the top of an ocean bottom which can be painted to realistically depict different types of corals and fishes. This ocean bottom can be seen through clear, smooth-surfaced sections of the front, sides, and back of the sculpture, thereby creating an “aquarium view” of the ocean bottom. The invention also contains a fish-eye lens, which can be moved in several directions, thereby affording a user numerous views of the surfer, wave, and ocean bottom from different perspectives.

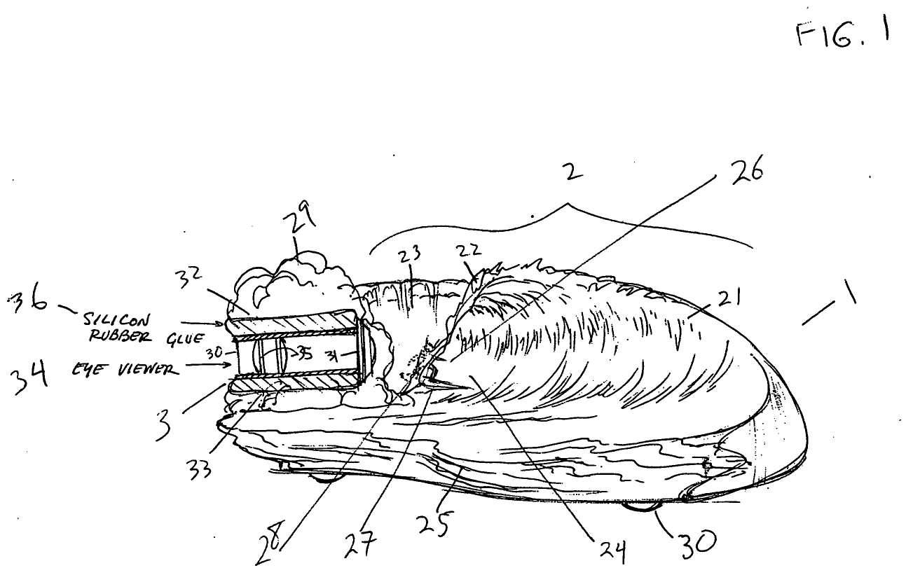

Referring now to the figures, FIG. 1 represents a side view of one iteration of the invention, a surfer on a wave, which relies upon an eyeglass viewer to provide a view of the surfer from inside the hollow portion of the wave, or tube. The invention, a surf sculpture generally indicated by reference number (1), consists of two portions, the wave, generally indicated by reference number (2), and the viewer, generally indicated by reference number (3). Said wave (2) consists of an unbroken shoulder (21) which is the portion of the wave which has not yet broken, a lip (22), which is that portion of the wave which is pitching out as the wave breaks, the pocket (24), which is the section of the wave with the most rapid vertical movement of water and therefore the portion of the wave which allows for optimum maneuvers, the breaking portion of the wave (23), and the “soup” (29) or whitewater portion of the wave after it has broken. In this figure, the surfer (27) is riding a surfboard (28) and is positioned just ahead of said “soup” (29). Said lip (22) partially obscures said surfer (27), creating a silhouette of the back portions of said surfer (27) and said surfboard (28). Upon the bottom of said surf sculpture (1) are three projecting knobs (30) upon which said surfing sculpture (1) rests as it is display upon a table or other flat surface. Said projecting knobs (30) are three in number as this creates a plane and allows said surf sculpture (1) to rest evenly upon a flat surface. Above said projecting knobs (30) is the ocean bottom (25) into which can be molded a variety of different shapes which can be painted a variety of colors to simulate different ocean environments.

Said viewer (generally indicated by reference number 3) consists of an eye viewer (34), consisting of two lenses (35) with a glass dust protector (30) on the end most distant from said surfer (27), and a third lens/end cap (31) on the end closest to said surfer (27). Said viewer (34) fits into a cavity molded into said surf sculpture (1) below the lower section (32) of said “soup” (29), and above the upper section (33) of said ocean bottom (25), and is attached securely with silicon rubber or a similar material forming the encasing material (36).

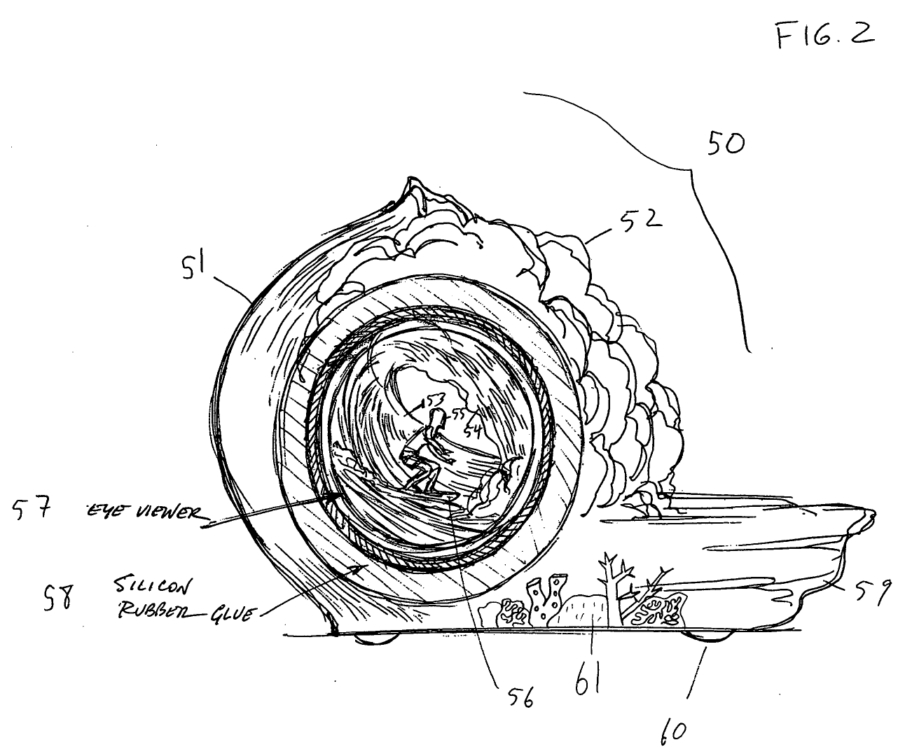

FIG. 2 illustrates the view a user of this invention would get through the eye viewer (57), referenced in FIG. 1 as (34). Said eye viewer (57) is attached to the surf sculpture, referenced in FIG. 1 as (1) and generally referred to here as (50), with the encasing material (58) being made of silicon rubber or a similar material. Surrounding said eye viewer (57) are several parts of the wave, referenced in FIG. 1 as (2), including the back of the wave (51), and the “soup” (52). Looking through said eye viewer (57), a user of this invention can look “out of the tube” and see the surfer (55) riding a surfboard (56), positioned just behind the lip (54) and surfing out toward the unbroken shoulder (53) of the wave. Said surf sculpture (50) also contains a clear front (59) through which an ocean bottom complete with a variety of corals and other marine life (61), into which can be molded a variety of different shapes which can be painted a variety of colors to simulate different ocean environments. Upon the bottom of said surf sculpture (50) are three projecting knobs (60) upon which said surf sculpture (50) rests as it is display upon a table or other flat surface.

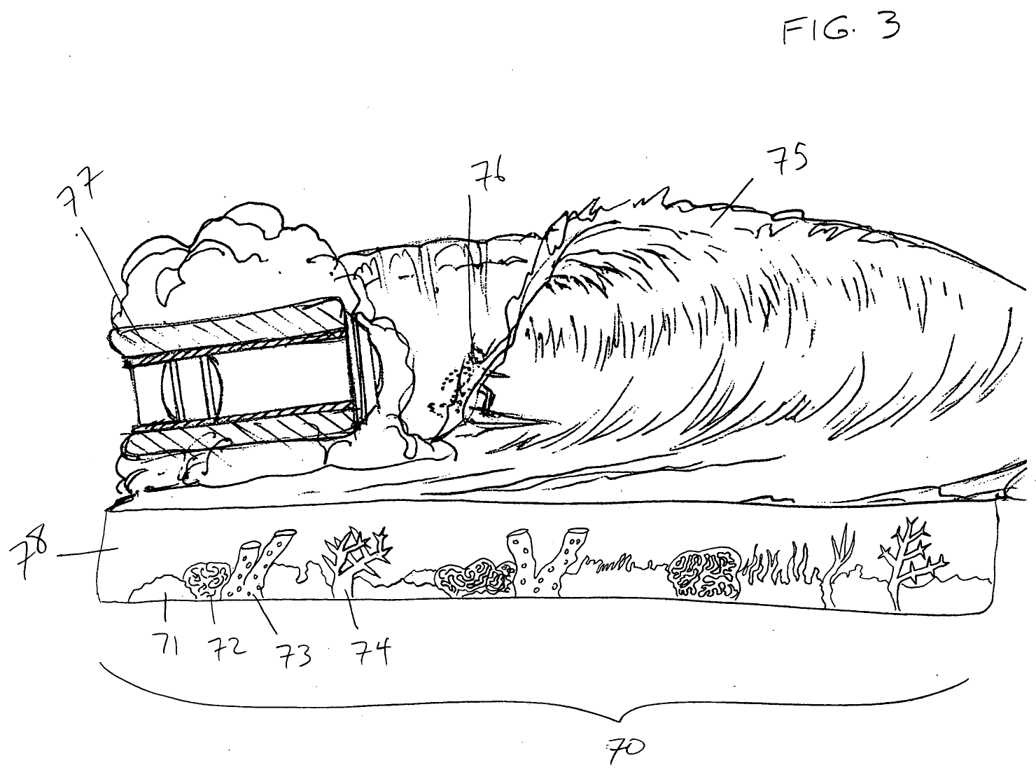

FIG. 3 is a front view of the sculpture illustrating in more detail the coral reef bottom (generally referred to by reference number 70). Included in the reef bottom are rocks (71), brain corals (72), sponges (73), and staghorn corals (74). The coral reef bottom (70) is clearly visible through a flat, clear bottom front section (78) of the invention. Above the clear bottom front section (78) is a wave (75) with a surfer (76), and an eyeglass viewer (77).

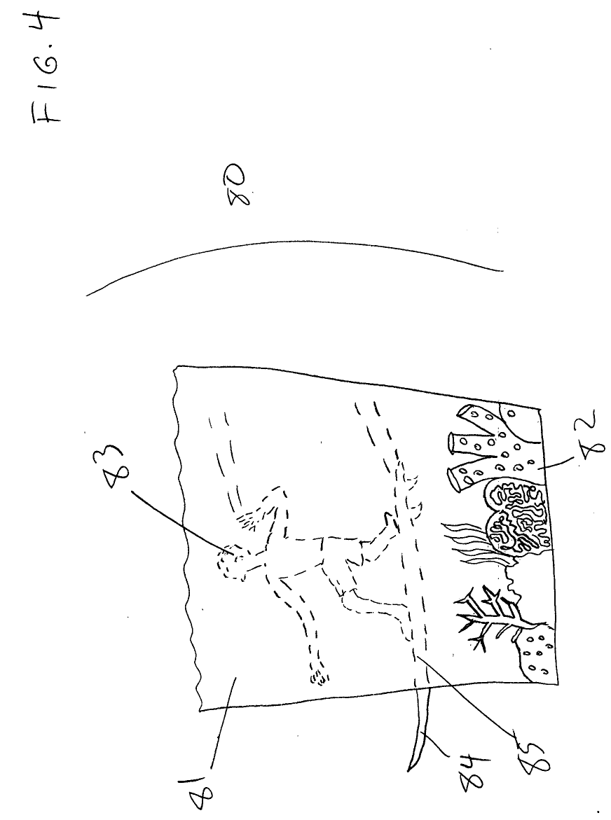

FIG. 4 is a back view of the invention, generally referred to by reference number 80, showing the “aquarium view” of the ocean bottom (82), which appears very clearly as the back of the wave (81) is made of non-textured, clear resin, allowing the viewer a clear view into the inside of the wave, directly through to the ocean bottom. Since the front of the wave (not labeled in this figure) is textured, the surfer (83) appears as a shadow or silhouette. The section of the surfboard protruding (84) beyond the back of the wave (81) does not appear in a shadow or silhouette form as it is not obscured by the textured front of the wave. The textured face of the wave does, however, partially obscure the surfer (83), and that portion of the surfer's surfboard partially obscured (85) by the back of the wave (81) and made less clear by the textured face of the wave.

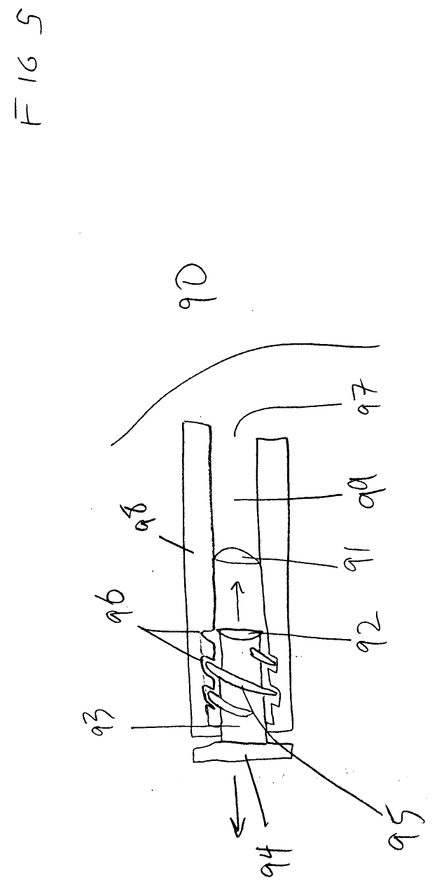

FIG. 5 is a side view of another iteration of the fish-eye lens portion of the invention. In this iteration, the lens component (generally indicated by reference number 90) has a fixed lens (91) and an adjustable lens (92). The adjustable lens (92) is attached to the end of a hollow viewing tube (93) which sits in a lens cavity (99) and is held in place by encasing material (98). The hollow viewing tube (93) has an eyepiece viewer (94) located on the end closest to where a user will view, and screw threads (95) which fit into screw thread cavities (96) built into the encasing material (98). The screw threads (95) turn as the eyepiece viewer (94) is turned, thereby moving the adjustable lens (92) to zoom in or zoom out, as the adjustable lens (92) moves forward and backward, toward the viewer and back toward the distal end (97) of the lens cavity (99).

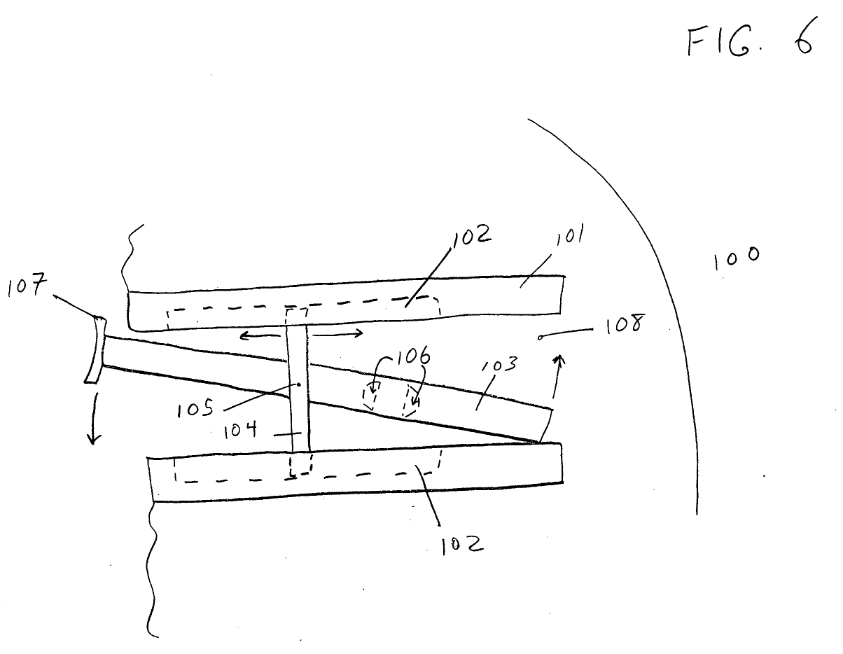

FIG. 6 is a side view of another iteration of the fish-eye lens portion of the invention. This iteration, generally referred to by reference number 100, shows how the hollow viewing tube (103) with its two lenses (106) can move both up and down (vertical arrows show range of movement), as it pivots off a pivot point (105), as well as being slid in either direction (horizontal arrows show direction of movement). The hollow viewing tube (103) is attached to a circular rotating device (104) through a pivot point (105), through which a piece of metal or plastic (not shown in this figure) holds the hollow viewing tube (103) in place. The circular rotating device (104) can be slid in either direction by pushing it or pulling the eyepiece viewer (107), along tracks (102) built into the encasing material (101), and rotated 360 degrees by twisting the eyepiece viewer (107) for leverage. In this iteration, the user can not only zoom in and zoom out by moving the hollow viewing tube (103) in and out of the lens cavity (108), but also move his/her line of sight in numerous different directions by twisting and moving the hollow viewing tube (103) around the pivot point (105) and rotating the entire circular rotating device (104).

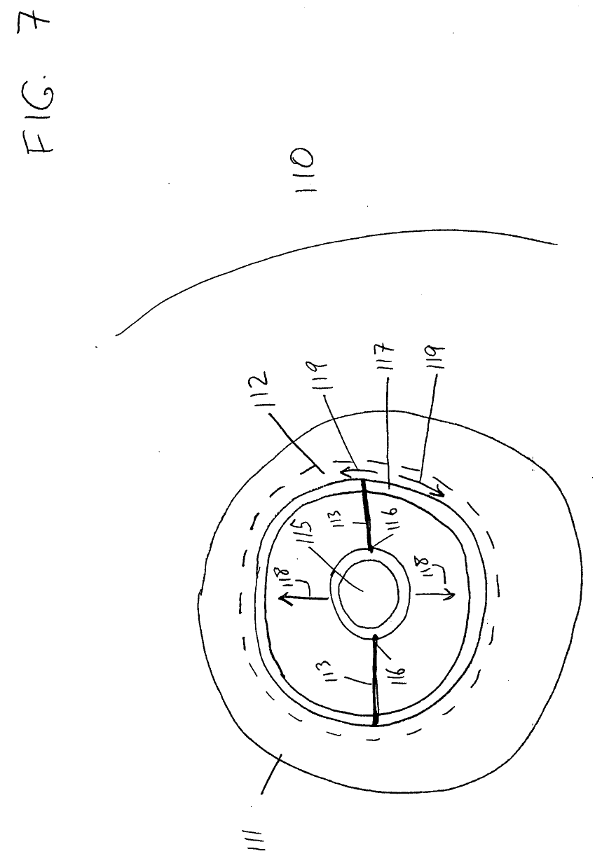

FIG. 7 is a side view looking directly into the invention described in FIG. 6. The invention, generally referred to by reference number 110, shows how the hollow viewing tube (115) is held in place around a pivot point (116). Built into the encasing material (111) is a track (112), an end view of which appears in this figure. In the track (112) is a circular rotating device (117) which can be rotated 360 degrees (shown by bent arrows (119)). Attached to the circular rotating device (117) are two pivot point connectors (113), made of metal, plastic, or another suitably rigid material, which connect the circular rotating device (117) to the hollow viewing tube (115), at the pivot points (116), allowing the range of motion indicated by the vertical arrows (118).

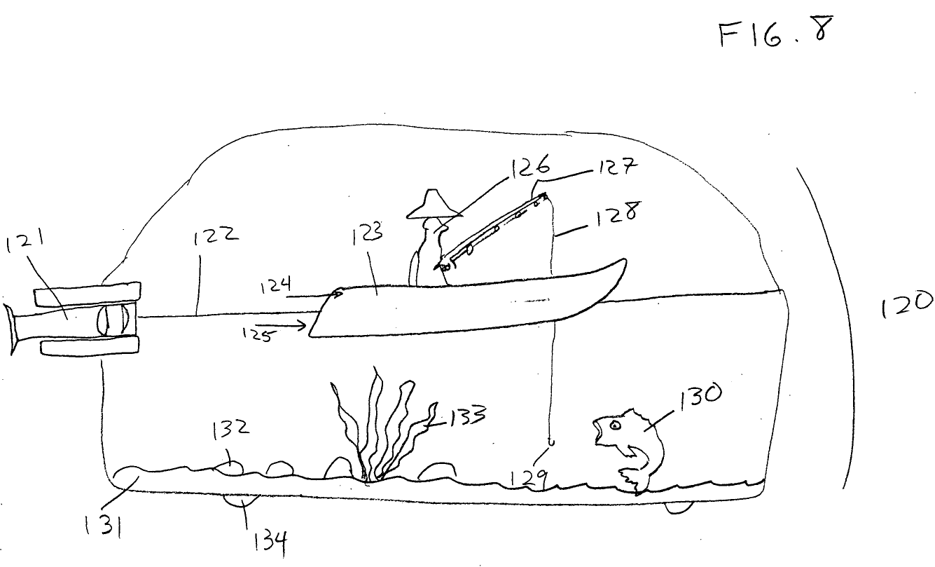

FIG. 8 shows a front cross sectional view of another iteration of the invention, generally referred to by reference number 120, in which the fish-eye lens (121) is located at the waterline (122), affording both above-water views (124) and below-water views (125) of the subject matter of the sculpture, in this case a fisherman (126) using a fishing pole (127) to dangle a line (128) from a kayak (123) below the waterline (122), where a fish (130) is attracted to the hook (129). This iteration also shows a river or lake bottom (131) which contains rocks (132) and aquatic vegetation (133). On the bottom of the invention are small projecting knobs (134) upon which the invention can rest on a table, dresser, bookshelf, or other flat surface.

What is claimed, is:

1. A method of making a sculpture comprising:
a resin cast of a surfer or other aquatic sportsperson where the resin cast is molded such that the bottom of the mold is indented to simulate realistically the undersea environment of a coral reef or other aquatic undersea environment, and
the bottom of the mold is painted in colors which realistically depict the corals or other undersea plants, animals, algas, and bottom environmental objects, and
the front of the sculpture is a textured aquatic environment, such as an ocean wave, depicting a realistic appearing wave, river surface or other section of water, and
an aquatic sportsperson molded out of plastic, metal, or a similar sturdy material, such as a surfer, kayaker, SCUBA diver, swimmer, or other water user engaged in his/her sport in or upon the textured aquatic environment, and
the back of the sculpture is clear, un-textured resin, which allows a viewer to see through the back of the wave or other body of water the sculpture is meant to depict, to see not only an “aquarium view” of the bottom and its undersea plants, animals, and algas, but also a silhouette or shadow view of the surfer or other aquatic sportsperson through the textured front face of the wave or other aquatic environment depicted by the sculpture, and
the sides of the sculpture have clear sections through which the bottom and its undersea plants, animals, and algas can be seen, and
the front section of the invention has a clear section through which the undersea environment can be clearly seen.

2. A sculpture made by the method of claim 1.

3. The method of making a sculpture of claim 1, where the invention also contains a viewing cavity, which contains a fish-eye lens, located in the back of the “tube” portion of the wave or other such suitable location on other types of aquatic sculptures, such that a viewer can, by looking through the lens, get a semi-realistic fish-eye view of what it would look like to view a surfer or other water user out of a tube or other aquatic environment.

4. A sculpture made by the method of claim 3.

5. The method of making a sculpture of claim 3 where the fish-eye lens is used on an air-water interface to provide a view of both the above-water and below-water environments and actions.

6. A sculpture made by the method of claim 5

7. The method of making a sculpture of claim 3, where the fish-eye lens is attached to a hollow viewing tube that can be moved forward and backward in the viewing cavity embedded into the “tube” section of the wave by means of screw threads attached to the hollow view tube which mesh with screw cavities embedded into the encasing material which surrounds the hollow viewing tube, thereby allowing a user to zoom in and zoom out on the surfer or other aquatic sportsperson.

8. A sculpture made by the method of claim 7.

9. The method of making a sculpture of claim 7 where the fish-eye lens is used on an air-water interface to provide a view of both the above water and below water environments and actions.

10. A sculpture made by the method of claim 9

11. The method of making a sculpture of claim 3, where,
the hollow viewing tube can be slid along tracks built into the encasing material, thereby allowing a user to zoom in and zoom out, and
where the hollow viewing tube can be rotated 360 degrees within the viewing cavity by means of the hollow viewing tube being attached to a circular rotating device through a pivot point, and
where the hollow viewing tube can be rotated in up and down about its pivot point, thereby affording a user numerous views of the surfer, wave, and ocean bottom from different perspectives, or of other aquatic sportspersons performing their aquatic sport.

12. A sculpture made by the method of claim 11.

13. The method of making a sculpture of claim 11 where the fish-eye lens is used on an air-water interface to provide a view of both the above water and below water environments and actions.

14. A sculpture made by the method of claim 13.
